(19) United States
(12) Patent Application Publication
(10) Pub. No.: US 2021/0292196 A1
(43) Pub. Date: Sep. 23, 2021

(54) REMOVAL OF METAL IONS FROM AQUEOUS SOLUTION VIA LIQUID/LIQUID EXTRACTION AND ELECTROCHEMISTRY

(71) Applicant: Massachusetts Institute of Technology, Cambridge, MA (US)

(72) Inventors: T. Alan Hatton, Sudbury, MA (US); Paul Brown, Boston, MA (US); Sahag Voskian, Cambridge, MA (US)

(21) Appl. No.: 16/325,032

(22) PCT Filed: Aug. 15, 2017
(86) PCT No.: PCT/US17/46978

§ 371 Date: Feb. 12, 2019

Related U.S. Application Data
(60) Provisional application No. 62/375,630, filed on Aug. 16, 2016.

(51) Int. Cl. C02F 1/467; C02F 1/26; C25C 3/00

(52) U.S. Cl. CPC C02F 1/4678; C02F 2101/20; C25C 3/00; C02F 1/26

(57) ABSTRACT

Disclosed are methods for using ionic liquids to extract metal ions from aqueous solution, and for subsequent recovery of the metal ions from the ionic liquids by electrochemical methods. The ionic liquids may be recycled and reused for further extraction.

### RELATED APPLICATION

This application claims the benefit of priority to U.S. Provisional Patent Application Ser. No. 62/375,630, filed Aug. 16, 2016.

### BACKGROUND OF THE INVENTION

The increased use of heavy metals and metalloids in industrial, agricultural and technological applications has led to their wide distribution and persistence in natural water bodies and soil [1, 2], Elements such as lead, cadmium, nickel, mercury, arsenic and copper may cause multiple organ damage even at low exposure (maximum contaminant level, MCL, of lead is 0.006 mg/L [3]) and are therefore of public health significance [4], Established technologies to remove metal ions from waste water are varied and include i) ion exchange resins [5,6], which have high capacities and removal efficiencies, but often prove problematic to regenerate; ii) membrane filtration [7], which is low energy and high efficiency but has problems of fouling; iii) coagulation and flocculation [8, 9], which requires the use of polymers; iv) flotation [10], which requires the use of surfactants; v) adsorption [11], where adsorbents are not always regenerable or are expensive (e.g., activated charcoal); vi) chemical precipitation [12-14], which is low cost but requires the use of a large amount of chemicals and can form sludges; vii) electrochemical treatment [15], which requires large capital investment; viii) solvent (liquid/liquid) extraction, which conventionally requires the use of volatile organic compounds (VOCs).

More recently novel liquid/liquid extractions have been made possible by the development of ionic liquids. Ionic liquids (ILs) are simply salts that are liquid at room temperature. They typically consist of a bulky cation and a small halogenated anion. These salts provide a non-aqueous yet polar medium and therefore have unusual solvent properties. The first ILs designed for heavy metal extraction favorably partitioned metals bound to complexing agents [16], but by appending the cation with metal-ion ligating functional groups, selective extraction of solute metals was achieved directly [17-20], These new functionalized ILs were named “task specific ILs”. However, removal of the metal ions from the IL remains difficult, and recyclability is therefore limited. To date the only removal process reported has been further washing of the IL with organic solvent [21]; an expensive and environmentally unfriendly approach.

### SUMMARY OF THE INVENTION

Accordingly, new methods are needed for extracting metals ions from aqueous solution using ILs, and for recycling ILs after the extraction is complete. The present invention provides a method to extract metal ions from aqueous solution for water treatment. The ionic liquids described have a controlled hydrophobic-hydrophilic balance that allows them to dissolve heavy metals at relatively high concentrations (for instance, about 0.20 mol kg⁻¹). The metal ions are chelated in the ion-pair region of the IL. The metal ions may be removed, and the IL regenerated, by applying an electrochemical potential.

### BRIEF DESCRIPTION OF THE DRAWINGS

FIG. 1A shows the structure of [eth-hex-en][Tf₂N],

FIG. 1B shows the structure of [Hbutylen][Tf₂N],

FIG. 2 shows (left) A blue 0.05 M aqueous solution of Cu(NO₃)₂ for comparison; and (right) 1 mL aqueous solutions of Cu(NO₃)₂ extracted into an ionic liquid phase [eth-hex-en][Tf₂N], The aqueous phases in the vials shown on the left are clear, whereas the ionic liquid phases are darkened, indicating that the metal ions have been extracted into the ionic liquid phases.

FIG. 3 shows Cu, Pb, and Ni deposition on a Pt electrode after chronoamperometry.

FIG. 4A shows the variation of density of [HButylen][Tf₂N], ρ, with temperature. Literature values for [bmim][Tf₂N] have been added for comparison [3, 4],

FIG. 4B shows the variation of density of [eth-hex-en][Tf₂N], ρ, with temperature. Literature values for [bmim][Tf₂N] have been added for comparison [3, 4],

FIG. 5 shows the removal of Cu(NO₃)₂ from aqueous solutions using [eth-hex-en][Tf₂N], Before stirring (top image), the aqueous phases are darkened by the presence of copper ions. After stirring (bottom image), the aqueous phases are clear.

FIG. 6 shows a cyclic voltammogram of [eth-hex-en] [Tf₂N] at 22° C. under N₂ at 0.05 mV/s with a Teflon treated carbon paper working electrode, Pt counter electrode and Ag|AgNO₃ reference electrode (black line). Other plots represent cyclic voltammagrams of ILs containing 0.01 M of Pb(NO₃)₂, Cu(NO₃)₂ and Co(NO₃)₂. The plot of Co(NO₃)₂ has the current scaled down by a factor of ten (10); (inset) image of Cu(0) deposited on a Pt working electrode via chronoamperometry.

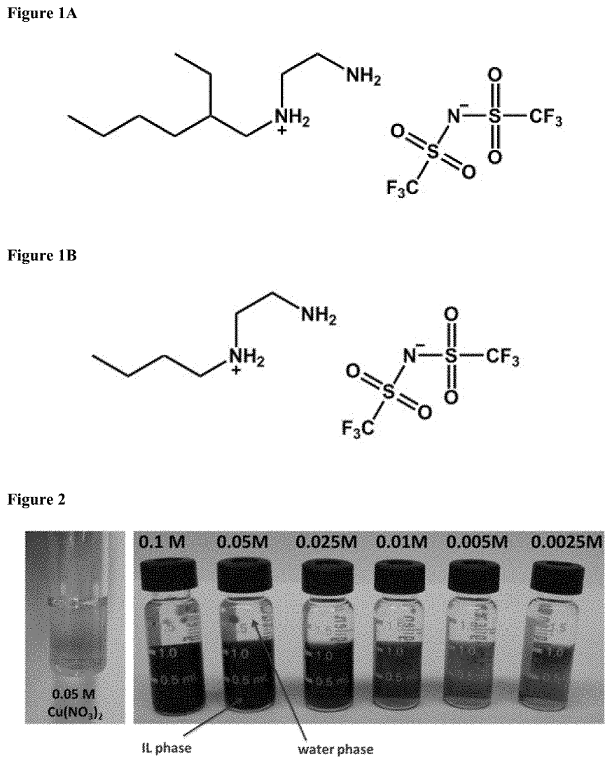

### DETAILED DESCRIPTION OF THE INVENTION

In a first aspect, the present disclosure provides a method of removing metal cations from an ionic liquid mixture, comprising:

providing an ionic liquid mixture comprising an ionic liquid and a plurality of metal cations; and

applying an electrical potential to the ionic liquid mixture, thereby removing from the ionic liquid mixture the plurality of metal cations.

In a second aspect, the present disclosure provides a method of removing metal cations from an aqueous mixture, comprising:

providing an aqueous mixture comprising water and a plurality of metal cations;

contacting the aqueous mixture with an ionic liquid, thereby forming an ionic liquid mixture comprising the ionic liquid and the plurality of metal cations; and

applying an electrical potential to the ionic liquid mixture, thereby removing from the ionic liquid mixture the plurality of metal cations.

In some embodiments of the first or second aspect, applying the electrical potential causes the plurality of metal cations to be electrochemically reduced. In some embodiments, applying the electrical potential causes the plurality of metal cations to be electrochemically reduced to metal atoms.

In some embodiments of the first or second aspect, the metal cations have a charge of +2. In some embodiments, the metal cations are cations of Mg, Fe, Hg, Sr, Sn, Ca, Cd, Zn, Co, Cu, Pb, Ni, Sc, V, Cr, Mn, or Ag. In some preferred embodiments, the metal cations are cations of Ni, Zn, Cu, Pb, or Co.

In some embodiments of the first or second aspect, the the metal cations have a charge of +3. In some embodiments, the metal cations are cations of La, Ce, Pr, Nd, Pm, Sm, Eu, Gd, Tb, Dy, Ho, Er, Tm, Yb, or Lu. In some embodiments, the metal cations are cations of Ac, Th, Pa, U, Np, Pu, Am, Cm, Bk, Cf, Es, Fm, Md, No, or Lr.

In some embodiments of the first or second aspect, the ionic liquid comprises a cation and an anion; and the cation is represented by structural formula I:

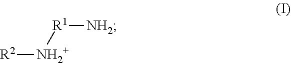

wherein, independently for each occurrence:
R¹ is —(C(R)₂)ₙ—;
n is 2, or 3;
R² is —(C(R′)₂)ₘ—R″;
m is 1, 2, 3, 4, 5, 6, 7, 8, 9, or 10; and
R is H, F, C₁-C₃ alkyl, or C₁-C₃ fluoroalkyl;
R′ is H, F, C₁-C₈ alkyl, or C₁-C₈ fluoroalkyl; and
R″ is H, F, C₁-C₃ alkyl, C₁-C₃ fluoroalkyl, C₁-C₃ alkyloxy, C₁-C₃ fluoroalkyloxy, C₆-C₁₀ aryl, C₂-C₈ alkenyl or C₂-C₈ fluoroalkenyl; wherein each instance of C₆-C₁₀ aryl is optionally substituted with one, two, three, four or five substituents independently selected from the group consisting of F, C₁-C₃ alkyl, C₁-C₃ fluoroalkyl, C₁-C₃ alkyloxy, and C₁-C₃ fluoroalkyloxy.
The variables in formula I may be further selected as described below.

In some embodiments of the first or second aspect, the ionic liquid comprises a cation and an anion. The cation may be dicationic or poly cationic. For instance, (4-vinylbenzyl)ethylene-diamine (VBEDA) may react with an appropriate acid to form an ionic liquid. This monomer may be polymerized or co-polymerized, thus allowing spin-coated or grafted layers to be created. Other poly cations that be used in ionic liquids include polyimidazolium, polypyrrolidinium, polyallydimethylammonium, and poly(3-acrylamidopropyl)trimethylammonium. In some embodiments, when the cation is a polymer, the cationic polymer is not a liquid at room temperature. According to these embodiments, a dilutant may be used to allow for ion mobility. In some embodiments, the dilutant is an ionic liquid such as l-butyl-3-methylimidazlium tetrafluoroborate. In some embodiments, the dilutant is an organic solvent such as acetonitrile.

In some embodiments, the cation is represented by structural formula II:

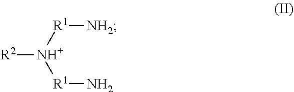

wherein, independently for each occurrence:
R¹ is, for each instance independently, —(C(R)₂)ₙ—;
n is, for each instance independently, 2, or 3;
R² is —(C(R′)₂)ₘ—R″;
m is 1, 2, 3, 4, 5, 6, 7, 8, 9, or 10; and
R is, for each instance independently, H, F, C₁-C₃ alkyl, or C₁-C₃ fluoroalkyl;
R′ is, for each instance independently, H, F, C₁-C₈ alkyl, or C₁-C₈ fluoroalkyl; and
R″ is H, F, C₁-C₃ alkyl, C₁-C₃ fluoroalkyl, C₁-C₃ alkyloxy, C₁-C₃ fluoroalkyloxy, C₆-C₁₀ aryl, C₂-C₈ alkenyl or C₂-C₈ fluoroalkenyl; wherein each instance of C₆-C₁₀ aryl is optionally substituted with one, two, three, four or five substituents independently selected from the group consisting of F, C₁-C₃ alkyl, C₁-C₃ fluoroalkyl, C₁-C₃ alkyloxy, and C₁-C₃ fluoroalkyloxy.
The variables in formula II may be further selected as described below.

In some embodiments of the first or second aspect, the cation is represented by one of structural formulas I or II, wherein n is 3. In preferred embodiments n is 2. The remainder of the variables, and the remainder of the other elements of the first or second aspect, may be selected as described above or below.

In some embodiments of the first or second aspect, the cation is represented by one of structural formulas I or II, wherein m is 1, 2, 3, or 4. In some embodiments, m is 5, 6, or 7. In some embodiments, m is 8, 9, or 10. In preferred embodiments, m is 6. The remainder of the variables in structural formula I, and the remainder of the other elements of the first or second aspect, may be selected as described above or below.

In some embodiments of the first or second aspect, the cation is represented by one of structural formulas I or II, wherein R is F. In some embodiments R is, for each instance independently, C₁-C₃ alkyl. In some embodiments R is, for each instance independently, C₁-C₃ fluoroalkyl. In preferred embodiments R is H. The remainder of the variables in structural formula I, and the remainder of the other elements of the first or second aspect, may be selected as described above or below.

In some embodiments of the first or second aspect, the cation is represented by one of structural formulas I or II, wherein R′ is F. In some embodiments R′ is C₁-C₈ alkyl. In some embodiments R′ is C₁-C₈ fluoroalkyl. In some preferred embodiments R′ is H. The remainder of the variables in structural formula I, and the remainder of the other elements of the first or second aspect, may be selected as described above or below.

In some embodiments of the first or second aspect, the cation is represented by one of structural formulas I or II, wherein R″ is F. In some embodiments, R″ is C₁-C₃ alkyl. In some embodiments, R″ is C₁-C₃ fluoroalkyl. In some embodiments, R″ is C₁-C₃ alkyloxy. In some embodiments, R″ is C₁-C₃ fluoroalkyloxy. In some embodiments, R″ is C₆-C₁₀ aryl. In some embodiments, R″ is C₂-C₅ alkenyl. In some embodiments, R″ is C₂-C₅ fluoroalkenyl. In some preferred embodiments, R″ is H. The remainder of the variables in structural formula I, and the remainder of the other elements of the first or second aspect, may be selected as described above or below.

In some embodiments of the first or second aspect, when R″ is C₆-C₁₀ aryl, it is unsubstituted. In some such embodiments, R″ is substituted with one substituent selected from the group consisting of F, C₁-C₃ alkyl, C₁-C₃ fluoroalkyl, C₁-C₃ alkyloxy, and C₁-C₃ fluoroalkyloxy. In some such embodiments, R″ is substituted with two substituents selected from the group consisting of F, C₁-C₃ alkyl, C₁-C₃ fluoroalkyl, C₁-C₃ alkyloxy, and C₁-C₃ fluoroalkyloxy. In some such embodiments, R″ is substituted with three such substituents. In some such embodiments, R″ is substituted with four such substituents. In some such embodiments, R″ is substituted with five such substituents. The remainder of the variables in structural formula I, the set of substituents for R″, and the remainder of the other elements of the first or second aspect, may be selected as described above or below.

In some embodiments of the first or second aspect, the one or more substituents on R″ are independently selected from F, C₁-C₃ alkyl, and C₁-C₃ fluoroalkyl. In some embodiments, the one or more substituents on R″ are independently selected from C₁-C₃ alkyl. The remainder of the variables in structural formula I, the number of substituents for R″, and the remainder of the other elements of the first or second aspect, may be selected as described above or below.

In some preferred embodiments of the first or second aspect, the cation is represented by one of structural formulas I or II, n is 2; and R is H. In some preferred embodiments, m is 6; and R″ is H. In some preferred embodiments, R² is 2-ethylhexyl. The remainder of the variables in structural formula I, and the remainder of the other elements of the first or second aspect, may be selected as described above or below.

In some embodiments of the first or second aspect, the anion is boron tetrafluoride, phosphorus tetrafluoride, phosphorus hexafluoride, alkylsulfonate, fluoroalkylsulfonate, arylsulfonate, bis(alkylsulfonyl)amide, bis(fluoroalkylsulfonyl)amide, bis(arylsulfonyl)amide, (fluoroalkylsulfonyl)(fluoroalkylcarbonyl)amide, halide, nitrate, nitrite, sulfate, hydrogensulfate, alkyl sulfate, aryl sulfate, carbonate, bicarbonate, carboxylate, phosphate, hydrogen phosphate, dihydrogen phosphate, hypochlorite, or an anionic site of a cation-exchange resin. In some embodiments, the anion is boron tetrafluoride, phosphorus tetrafluoride, phosphorus hexafluoride, halide, nitrate, nitrite, sulfate, hydrogensulfate, carbonate, bicarbonate, phosphate, hydrogen phosphate, dihydrogen phosphate, hypochlorite, or an anionic site of a cation-exchange resin. In some embodiments, the anion is C₁-C₁₂ alkylsulfonate, C₁-C₁₂ fluoroalkylsulfonate, C₆-C₁₀ arylsulfonate, C₂-C₂₄ bis(alkylsulfonyl)amide, C₂-C₂₄ bis(fluoroalkylsulfonyl)amide, C₁₂-C₂₀ bis(arylsulfonyl)amide, C₂-C₂₄ (fluoroalkylsulfonyl)(fluoroalkylcarbonyl)amide, C₁-C₁₂ alkyl sulfate, C₆-C₁₀ aryl sulfate, or C₁-C₁₂ carboxylate. In some embodiments, the anion is boron tetrafluoride, phosphorus hexafluoride, methanesulfonate, trifluoromethanesulfonate, benzenesulfonate, p-toluenesulfonate, bis(methanesulfonyl)amide, bis(trifluoromethanesulfonyl)amide, bis(benzenesulfonyl)amide, or bis(p-toluenesulfonyl)amide. In some embodiments, the anion is methanesulfonate, trifluoromethanesulfonate, benzenesulfonate, p-toluenesulfonate, bis(methanesulfonyl)amide, bis(trifluoromethanesulfonyl)amide, bis(benzenesulfonyl)amide, or bis(p-toluenesulfonyl)amide. In some embodiments, the anion is bis(methanesulfonyl)amide, bis(trifluoromethanesulfonyl)amide, bis(benzenesulfonyl)amide, or bis(p-toluenesulfonyl)amide. In some embodiments, the anion is bis(trifluoromethanesulfonyl)amide or (trifluoromethanesulfonyl)(trifluoroacetyl)amide. In some preferred embodiments, the anion is bis(trifluoroethanesulfonyl)amide.

In some embodiments, the anion may be polymerizable. In some embodiments the anion may be a polyanion (either a homopolyer or a copolymer), such as a polyvinyl sulfonate, a polyphosphate, a poly carboxylate, a poly(acrylamide)-2-methylpropane sulfonate, a polyacrylic acid, or a polymer having trifluoromethanesulfonamide anions in its backbone [Polymer, 2004, 45, 1577-1582],

In some embodiments, when the anion is a polymer, the anionic polymer is not a liquid at room temperature. In such embodiments, a dilutant may be used to allow for ion mobility. In some embodiments, the dilutant is an ionic liquid, such as 1-butyl-3-methylimidazolium tetrafluoroborate. In some embodiments, the dilutant is an organic solvent, such as acetonitrile.

### Definitions

Unless otherwise defined herein, scientific and technical terms used in this application shall have the meanings that are commonly understood by those of ordinary skill in the art. Generally, nomenclature used in connection with, and techniques of, chemistry described herein, are those well-known and commonly used in the art.

The term “acyl” is art-recognized and refers to a group represented by the general formula hydrocarbylC(O)—, preferably alkylC(O)—.

The term “acylamino” is art-recognized and refers to an amino group substituted with an acyl group and may be represented, for example, by the formula hydrocarbylC(O)NH—.

The term “acyloxy” is art-recognized and refers to a group represented by the general formula hydrocarbylC(O)O—, preferably alkylC(O)O—.

The term “alkoxy” refers to an alkyl group, having an oxygen attached thereto. Representative alkoxy groups include methoxy, trifluoromethoxy, ethoxy, propoxy, tert-butoxy and the like.

The term “alkoxyalkyl” refers to an alkyl group substituted with an alkoxy group and may be represented by the general formula alkyl-O-alkyl.

The term “alkenyl”, as used herein, refers to an aliphatic group containing at least one double bond and is intended to include both “unsubstituted alkenyls” and “substituted alkenyls”, the latter of which refers to alkenyl moieties having substituents replacing a hydrogen on one or more carbons of the alkenyl group. Typically, a straight chained or branched alkenyl group has from 1 to about 20 carbon atoms, preferably from 1 to about 10 unless otherwise defined. Such substituents may occur on one or more carbons that are included or not included in one or more double bonds. Moreover, such substituents include all those contemplated for alkyl groups, as discussed below, except where stability is prohibitive. For example, substitution of alkenyl groups by one or more alkyl, carbocyclyl, aryl, heterocyclyl, or heteroaryl groups is contemplated.

An “alkyl” group or “alkane” is a straight chained or branched non-aromatic hydrocarbon which is completely saturated. Typically, a straight chained or branched alkyl group has from 1 to about 20 carbon atoms, preferably from 1 to about 10 unless otherwise defined. Examples of straight chained and branched alkyl groups include methyl, ethyl, n-propyl, iso-propyl, n-butyl, sec-butyl, tert-butyl, pentyl, hexyl, pentyl and octyl.

Moreover, the term “alkyl” as used throughout the specification, examples, and claims is intended to include both “unsubstituted alkyls” and “substituted alkyls”, the latter of which refers to alkyl moieties having substituents replacing a hydrogen on one or more substitutable carbons of the hydrocarbon backbone. Such substituents, if not otherwise specified, can include, for example, a halogen (e.g., fluoro), a hydroxyl, a carbonyl (such as a carboxyl, an alkoxycarbonyl, a formyl, or an acyl), a thiocarbonyl (such as a thioester, a thioacetate, or a thioformate), an alkoxy, a phosphoryl, a phosphate, a phosphonate, a phosphinate, an amino, an amido, an amidine, an imine, a cyano, a nitro, an azido, a sulfhydryl, an alkylthio, a sulfate, a sulfonate, a sulfamoyl, a sulfonamido, a sulfonyl, a heterocyclyl, an aralkyl, or an aromatic or heteroaromatic moiety. In preferred embodiments, the substituents on substituted alkyls are selected from C₁₋₆ alkyl, C₃₋₆ cycloalkyl, halogen, carbonyl, cyano, or hydroxyl. In more preferred embodiments, the substituents on substituted alkyls are selected from fluoro, carbonyl, cyano, or hydroxyl. It will be understood by those skilled in the art that the moieties substituted on the hydrocarbon chain can themselves be substituted, if appropriate. For instance, the substituents of a substituted alkyl may include substituted and unsubstituted forms of amino, azido, imino, amido, phosphoryl (including phosphonate and phosphinate), sulfonyl (including sulfate, sulfonamido, sulfamoyl and sulfonate), and silyl groups, as well as ethers, alkylthios, carbonyls (including ketones, aldehydes, carboxylates, and esters), —CF₃, —CN and the like. Exemplary substituted alkyls are described below. Cycloalkyls can be further substituted with alkyls, alkenyls, alkoxys, alkylthios, aminoalkyls, carbonyl-substituted alkyls, —CF₃, —CN, and the like.

The term “C_{x-y}” when used in conjunction with a chemical moiety, such as, acyl, acyloxy, alkyl, alkenyl, alkynyl, or alkoxy is meant to include groups that contain from x to y carbons in the chain. For example, the term “C_{x-y} alkyl” refers to substituted or unsubstituted saturated hydrocarbon groups, including straight-chain alkyl and branched-chain alkyl groups that contain from x to y carbons in the chain, including haloalkyl groups. Preferred haloalkyl groups include trifluoromethyl, difluoromethyl, 2,2,2-trifluoroethyl, and pentafluoroethyl. Co alkyl indicates a hydrogen where the group is in a terminal position, a bond if internal. The terms “C_{2-y} alkenyl” and “C_{2-y} alkynyl” refer to substituted or unsubstituted unsaturated aliphatic groups analogous in length and possible substitution to the alkyls described above, but that contain at least one double or triple bond respectively.

The term “alkylamino”, as used herein, refers to an amino group substituted with at least one alkyl group.

The term “alkylthio”, as used herein, refers to a thiol group substituted with an alkyl group and may be represented by the general formula alkylS-.

The term “arylthio”, as used herein, refers to a thiol group substituted with an alkyl group and may be represented by the general formula arylS-.

The term “alkynyl”, as used herein, refers to an aliphatic group containing at least one triple bond and is intended to include both “unsubstituted alkynyls” and “substituted alkynyls”, the latter of which refers to alkynyl moieties having substituents replacing a hydrogen on one or more carbons of the alkynyl group. Typically, a straight chained or branched alkynyl group has from 1 to about 20 carbon atoms, preferably from 1 to about 10 unless otherwise defined. Such substituents may occur on one or more carbons that are included or not included in one or more triple bonds. Moreover, such substituents include all those contemplated for alkyl groups, as discussed above, except where stability is prohibitive. For example, substitution of alkynyl groups by one or more alkyl, carbocyclyl, aryl, heterocyclyl, or heteroaryl groups is contemplated.

The term “amide”, as used herein, refers to a group

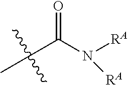

wherein each R^{A} independently represent a hydrogen or hydrocarbyl group, or two R^{A} are taken together with the N atom to which they are attached complete a heterocycle having from 4 to 8 atoms in the ring structure.

The terms “amine” and “amino” are art-recognized and refer to both unsubstituted and substituted amines and salts thereof, e.g., a moiety that can be represented by

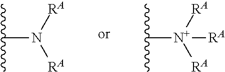

wherein each R^{A} independently represents a hydrogen or a hydrocarbyl group, or two R^{A} are taken together with the N atom to which they are attached complete a heterocycle having from 4 to 8 atoms in the ring structure.

The term “aminoalkyl”, as used herein, refers to an alkyl group substituted with an amino group.

The term “AOT” refers to 1,4-bis(2-ethylhexoxy)-1,4-dioxobutane-2-sulfonate.

The term “aralkyl”, as used herein, refers to an alkyl group substituted with an aryl group.

The term “aryl” as used herein include substituted or unsubstituted single-ring aromatic groups in which each atom of the ring is carbon. Preferably the ring is a 6- or 20-membered ring, more preferably a 6-membered ring. The term “aryl” also includes polycyclic ring systems having two or more cyclic rings in which two or more carbons are common to two adjoining rings wherein at least one of the rings is aromatic, e.g., the other cyclic rings can be cycloalkyls, cycloalkenyls, cycloalkynyls, aryls, heteroaryls, and/or heterocyclyls. Aryl groups include benzene, naphthalene, phenanthrene, phenol, aniline, and the like.

The term “bmim” refers to 1-Butyl-3-methylimidazolium.

The term “carbamate” is art-recognized and refers to a group

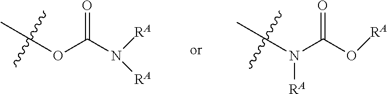

wherein each R^{A} independently represent hydrogen or a hydrocarbyl group, such as an alkyl group, or both R^{A} taken together with the intervening atom(s) complete a heterocycle having from 4 to 8 atoms in the ring structure.

The terms “carbocycle”, and “carbocyclic”, as used herein, refers to a saturated or unsaturated ring in which each atom of the ring is carbon. Preferably, a carbocylic group has from 3 to 20 carbon atoms. The term carbocycle includes both aromatic carbocycles and non-aromatic carbocycles. Non-aromatic carbocycles include both cycloalkane rings, in which all carbon atoms are saturated, and cycloalkene rings, which contain at least one double bond. “Carbocycle” includes 5-7 membered monocyclic and 8-12 membered bicyclic rings. Each ring of a bicyclic carbocycle may be selected from saturated, unsaturated and aromatic rings. Carbocycle includes bicyclic molecules in which one, two or three or more atoms are shared between the two rings. The term “fused carbocycle” refers to a bicyclic carbocycle in which each of the rings shares two adjacent atoms with the other ring. Each ring of a fused carbocycle may be selected from saturated, unsaturated and aromatic rings. In an exemplary embodiment, an aromatic ring, e.g., phenyl, may be fused to a saturated or unsaturated ring, e.g., cyclohexane, cyclopentane, or cyclohexene. Any combination of saturated, unsaturated and aromatic bicyclic rings, as valence permits, is included in the definition of carbocyclic. Exemplary “carbocycles” include cyclopentane, cyclohexane, bicyclo[2.2.1]heptane, 1,5-cyclooctadiene, 1,2,3,4-tetrahydronaphthalene, bicyclo[4.2.0]oct-3-ene, naphthalene and adamantane. Exemplary fused carbocycles include decalin, naphthalene, 1,2,3,4-tetrahydronaphthalene, bicyclo[4.2.0]octane, 4,5,6,7-tetrahydro-1H-indene and bicyclo[4.1.0]hept-3-ene. “Carbocycles” may be susbstituted at any one or more positions capable of bearing a hydrogen atom.

A “cycloalkyl” group is a cyclic hydrocarbon which is completely saturated. “Cycloalkyl” includes monocyclic and bicyclic rings. Preferably, a cycloalkyl group has from 3 to 20 carbon atoms. Typically, a monocyclic cycloalkyl group has from 3 to about 10 carbon atoms, more typically 3 to 8 carbon atoms unless otherwise defined. The second ring of a bicyclic cycloalkyl may be selected from saturated, unsaturated and aromatic rings. Cycloalkyl includes bicyclic molecules in which one, two or three or more atoms are shared between the two rings. The term “fused cycloalkyl” refers to a bicyclic cycloalkyl in which each of the rings shares two adjacent atoms with the other ring. The second ring of a fused bicyclic cycloalkyl may be selected from saturated, unsaturated and aromatic rings. A “cycloalkenyl” group is a cyclic hydrocarbon containing one or more double bonds.

The term “carbocyclylalkyl”, as used herein, refers to an alkyl group substituted with a carbocycle group.

The term “carbonate”, as used herein, refers to a group —OCO₂—R^{A}, wherein R^{A} represents a hydrocarbyl group.

The term “carboxy”, as used herein, refers to a group represented by the formula —CO₂H.

The term “ester”, as used herein, refers to a group —C(O)OR^{A} wherein R^{A} represents a hydrocarbyl group.

The term “ether”, as used herein, refers to a hydrocarbyl group linked through an oxygen to another hydrocarbyl group. Accordingly, an ether substituent of a hydrocarbyl group may be hydrocarbyl-O—. Ethers may be either symmetrical or unsymmetrical. Examples of ethers include, but are not limited to, heterocycle-O-heterocycle and aryl-O-heterocycle. Ethers include “alkoxyalkyl” groups, which may be represented by the general formula alkyl-O-alkyl.

The terms “halo” and “halogen” as used herein means halogen and includes chloro, fluoro, bromo, and iodo.

The terms “hetaralkyl” and “heteroaralkyl”, as used herein, refers to an alkyl group substituted with a hetaryl group.

The term “heteroalkyl”, as used herein, refers to a saturated or unsaturated chain of carbon atoms and at least one heteroatom, wherein no two heteroatoms are adjacent.

The terms “heteroaryl” and “hetaryl” include substituted or unsubstituted aromatic single ring structures, preferably 5- to 20-membered rings, more preferably 5- to 6-membered rings, whose ring structures include at least one heteroatom, preferably one to four heteroatoms, more preferably one or two heteroatoms. The terms “heteroaryl” and “hetaryl” also include polycyclic ring systems having two or more cyclic rings in which two or more carbons are common to two adjoining rings wherein at least one of the rings is heteroaromatic, e.g., the other cyclic rings can be cycloalkyls, cycloalkenyls, cycloalkynyls, aryls, heteroaryls, and/or heterocyclyls. Heteroaryl groups include, for example, pyrrole, furan, thiophene, imidazole, oxazole, thiazole, pyrazole, pyridine, pyrazine, pyridazine, and pyrimidine, and the like.

The term “heteroatom” as used herein means an atom of any element other than carbon or hydrogen. Preferred heteroatoms are nitrogen, oxygen, and sulfur.

The terms “heterocyclyl”, “heterocycle”, and “heterocyclic” refer to substituted or unsubstituted non-aromatic ring structures, preferably 3- to 20-membered rings, more preferably 3- to 7-membered rings, whose ring structures include at least one heteroatom, preferably one to four heteroatoms, more preferably one or two heteroatoms. The terms “heterocyclyl” and “heterocyclic” also include polycyclic ring systems having two or more cyclic rings in which two or more carbons are common to two adjoining rings wherein at least one of the rings is heterocyclic, e.g., the other cyclic rings can be cycloalkyls, cycloalkenyls, cycloalkynyls, aryls, heteroaryls, and/or heterocyclyls. Heterocyclyl groups include, for example, piperidine, piperazine, pyrrolidine, morpholine, lactones, lactams, and the like.

The term “heterocyclylalkyl”, as used herein, refers to an alkyl group substituted with a heterocycle group.

The term “hydrocarbyl”, as used herein, refers to a group that is bonded through a carbon atom, wherein that carbon atom does not have a ═O or ═S substituent. Hydrocarbyls may optionally include heteroatoms. Hydrocarbyl groups include, but are not limited to, alkyl, alkenyl, alkynyl, alkoxyalkyl, aminoalkyl, aralkyl, aryl, aralkyl, carbocyclyl, cycloalkyl, carbocyclylalkyl, heteroaralkyl, heteroaryl groups bonded through a carbon atom, heterocyclyl groups bonded through a carbon atom, heterocyclylakyl, or hydroxyalkyl. Thus, groups like methyl, ethoxy ethyl, 2-pyridyl, and trifluoromethyl are hydrocarbyl groups, but substituents such as acetyl (which has a ═O substituent on the linking carbon) and ethoxy (which is linked through oxygen, not carbon) are not.

The term “hydroxyalkyl”, as used herein, refers to an alkyl group substituted with a hydroxy group.

The term “lower” when used in conjunction with a chemical moiety, such as, acyl, acyloxy, alkyl, alkenyl, alkynyl, or alkoxy is meant to include groups where there are six or fewer non-hydrogen atoms in the substituent. A “lower alkyl”, for example, refers to an alkyl group that contains six or fewer carbon atoms. In certain embodiments, acyl, acyloxy, alkyl, alkenyl, alkynyl, or alkoxy substituents defined herein are respectively lower acyl, lower acyloxy, lower alkyl, lower alkenyl, lower alkynyl, or lower alkoxy, whether they appear alone or in combination with other substituents, such as in the recitations hydroxyalkyl and aralkyl (in which case, for example, the atoms within the aryl group are not counted when counting the carbon atoms in the alkyl substituent).

The terms “polycyclyl”, “polycycle”, and “polycyclic” refer to two or more rings (e.g., cycloalkyls, cycloalkenyls, cycloalkynyls, aryls, heteroaryls, and/or heterocyclyls) in which two or more atoms are common to two adjoining rings, e.g., the rings are “fused rings”. Each of the rings of the poly cycle can be substituted or unsubstituted. In certain embodiments, each ring of the poly cycle contains from 3 to 10 atoms in the ring, preferably from 5 to 7.

In the phrase “poly(meta-phenylene oxides)”, the term “phenylene” refers inclusively to 6-membered aryl or 6-membered heteroaryl moieties. Exemplary poly(meta-phenylene oxides) are described in the first through twentieth aspects of the present disclosure.

The term “silyl” refers to a silicon moiety with three hydrocarbyl moieties attached thereto.

The term “substituted” refers to moieties having substituents replacing a hydrogen on one or more carbons of the backbone. It will be understood that “substitution” or “substituted with” includes the implicit proviso that such substitution is in accordance with permitted valence of the substituted atom and the substituent, and that the substitution results in a stable compound, e.g., which does not spontaneously undergo transformation such as by rearrangement, cyclization, elimination, etc. Moieties that may be substituted can include any appropriate substituents described herein, for example, acyl, acylamino, acyloxy, alkoxy, alkoxyalkyl, alkenyl, alkyl, alkylamino, alkylthio, arylthio, alkynyl, amide, amino, aminoalkyl, aralkyl, carbamate, carbocyclyl, cycloalkyl, carbocyclylalkyl, carbonate, ester, ether, heteroaralkyl, heterocyclyl, heterocyclylalkyl, hydrocarbyl, silyl, sulfone, or thioether. As used herein, the term “substituted” is contemplated to include all permissible substituents of organic compounds. In a broad aspect, the permissible substituents include acyclic and cyclic, branched and unbranched, carbocyclic and heterocyclic, aromatic and non-aromatic substituents of organic compounds. The permissible substituents can be one or more and the same or different for appropriate organic compounds. For purposes of this invention, the heteroatoms such as nitrogen may have hydrogen substituents and/or any permissible substituents of organic compounds described herein which satisfy the valences of the heteroatoms. Substituents can include any substituents described herein, for example, a halogen, a hydroxyl, a carbonyl (such as a carboxyl, an alkoxy carbonyl, a formyl, or an acyl), a thiocarbonyl (such as a thioester, a thioacetate, or a thioformate), an alkoxy, a phosphoryl, a phosphate, a phosphonate, a phosphinate, an amino, an amido, an amidine, an imine, a cyano, a nitro, an azido, a sulfhydryl, an alkylthio, a sulfate, a sulfonate, a sulfamoyl, a sulfonamido, a sulfonyl, a heterocyclyl, an aralkyl, or an aromatic or heteroaromatic moiety. In preferred embodiments, the substituents on substituted alkyls are selected from C₁₋₆ alkyl, C₃₋₆ cycloalkyl, halogen, carbonyl, cyano, or hydroxyl. In more preferred embodiments, the substituents on substituted alkyls are selected from fluoro, carbonyl, cyano, or hydroxyl. It will be understood by those skilled in the art that substituents can themselves be substituted, if appropriate. Unless specifically stated as “unsubstituted,” references to chemical moieties herein are understood to include substituted variants. For example, reference to an “aryl” group or moiety implicitly includes both substituted and unsubstituted variants.

The term “sulfonate” is art-recognized and refers to the group SO₃H, or a pharmaceutically acceptable salt thereof.

The term “sulfone” is art-recognized and refers to the group —S(O)₂—R^{A}, wherein R^{A} represents a hydrocarbyl.

The term “thioether”, as used herein, is equivalent to an ether, wherein the oxygen is replaced with a sulfur.

### EXAMPLES

The invention now being generally described, it will be more readily understood by reference to the following examples, which are included merely for purposes of illustration of certain aspects and embodiments of the present invention, and are not intended to limit the invention.

### Example 1: Synthesis and Physical Characterization of 2-Ethylhexyl(ethylenediaminium) bis(trifluoroethanesulfonyl)amide, [eth-hex-en][Tf₂N]

In order to increase hydrophobicity, reduce the melting point, and improve physicochemical properties, ionic liquids with more hydrophobic side chains were prepared.

2-Ethylhexyl(ethylenediaminium) bis(trifluoroethanesulfonyl)amide, [eth-hex-en][Tf₂N], with the structural formula depicted below, was synthesized according to literature [26],

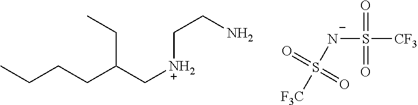

Bis(trifluoromethane)sulfonamide (HTf₂N)>95%) was purchased from Santa Cruz Biotechnology, 2-ethylhexyl bromide (95%), ethylenediamine (>99%), copper (II) nitrate trihydrate (puriss), lead (II) nitrate (≥99%), and cobalt (II) nitrate hexahydrate (>98%) were purchased from Sigma Aldrich and used without further purification.

2-Ethylhexyl(ethylenediamine) was synthesized by adding 2-ethylhexyl bromide (30 mL, 0.169 moles) dropwise to an excess of ethylenediamine (300 mL, 4.50 moles) over 2 hours. After the reaction mixture was stirred overnight the unreacted ethylenediamine was removed at reduced pressure. The remnants were washed with 40% sodium hydroxide solution, the top layer was removed and further washed with water. The product was then purified by distillation under reduced pressure (90° C., ˜10 mbar).

2-ethylhexyl(ethylenediamine) was neutralized with acid (HTf₂N) by mixing in 1:1 molar ratio in diethyl ether solution and then isolated by evaporation of the diethyl ether. The compound was dried in vacuo until the water content fell below 500 ppm (as measured by Karl Fischer titration). Purity of the compounds was confirmed by elemental analysis and ¹H-NMR. Elemental analysis results experimental and theoretical (in brackets), C=24.24 (24.19); H=4.43 (4.28); N=10.41 (10.58), S=15.90 (16.14). ¹H-NMR (MEOD, 300 MHz), (δ=0.93-1.00) (3H, t), (δ=1.32-1.64) (4H, m), (δ=2.72-2.81) (2H, m) (δ=2.85-3.00), (4H, m), (δ=4.89), (4H, s). The ionic liquid had a melting point of about −100° C. N-ethylbenzene(ethylenediaminium) bis(trifluoroethanesulfonyl)amide was prepared similarly.

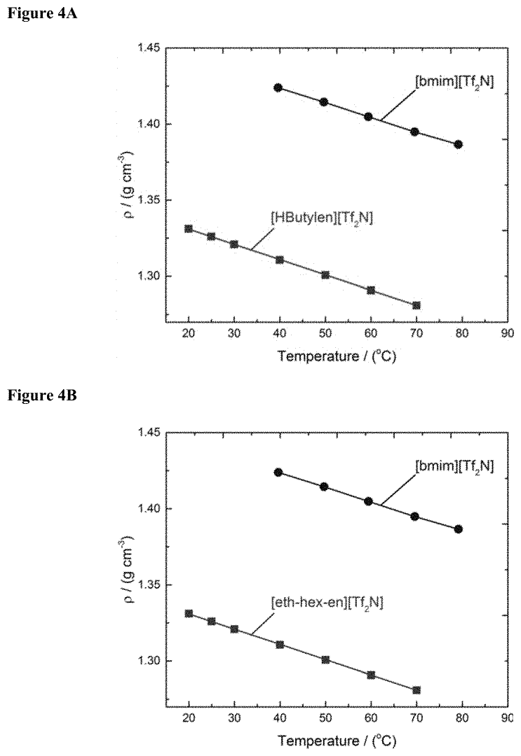

Density was measured with an Anton Paar vibrating tube densitometer (DMA 4100) from 20 to 70° C. Measurements were viscosity corrected and carried out in atmospheric conditions (FIG. 4, Table 3). The instrument was calibrated using ultrapure water (Elga, resistivity=18 MΩ cm) and atmospheric air. The temperature dependence fit a simple linear regression, and by plotting ln(ρ) as a function of T, the thermal expansion coefficient (d ln(ρ)/dT=−αₚ) was calculated. αₚ=7.68×10⁻⁴° C.⁻¹

TABLE 1
Experimental values of density of [eth-hex-en][Tf₂N],
ρ, as a function of temperature.

| Temperature/ | Density/ |
|---|---|
| ° C. | (g cm⁻³) |
| 20 | 1.3310 |
| 25 | 1.3259 |
| 30 | 1.3208 |
| 40 | 1.3106 |
| 50 | 1.3006 |
| 60 | 1.2907 |
| 70 | 1.2809 |

### Example 2: Metal Extraction by [Eth-Hex-En][Tf₂N] from Aqueous Solution

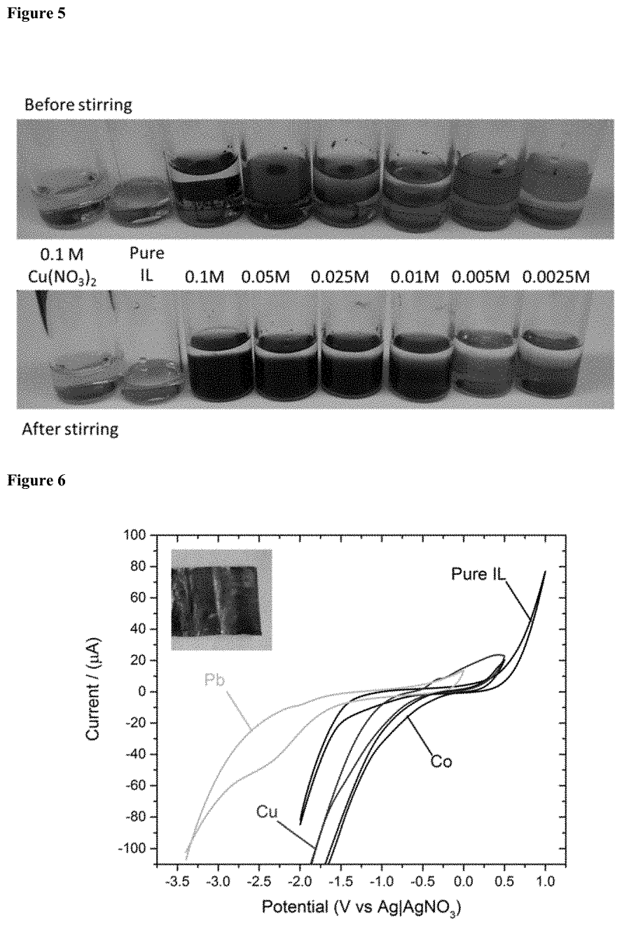

The extraction of various metal nitrates (Cu, Pb, Co) from aqueous solution into the ionic liquid phase was tested at different concentrations (0.1 M-0.0025 M). The extractions were achieved by mixing 4 mL of IL with 4 mL of water using a vortex mixer (10 s), followed by centrifugation (1000 rpm, 1 minute) (FIG. 5). The metal content of the aqueous phase was investigated using ICP analysis (Perkin Elmer, Optima 8000 ICP-OES, USA). In each case, more than 99.95% of metal ions were removed from solution (Tables 4 and 5).

TABLE 2
Results of copper nitrate extraction studies in
[eth-hex-en][Tf₂N]

| [Cu(NO₃)₂]/M | [Cu(NO₃)₂]/(M × 10⁻⁵) | % Cu(NO₃)₂ |
|---|---|---|
| (before extraction) | (after extraction) | removed |
| 0.1000 | 2.28 | 99.98 |
| 0.0800 | 2.00 | 99.97 |
| 0.0500 | 2.41 | 99.95 |
| 0.0400 | 1.77 | 99.95 |
| 0.0250 | 0.51 | 99.96 |
| 0.0100 | 0.008 | 99.99 |
| 0.0050 | 0.021 | 99.96 |
| 0.0025 | 0.009 | 99.56 |

TABLE 3
Results of various transition metal nitrates
extracted from water by [eth-hex-en][Tf₂N]

| | [Metal]/(M) | [Metal]/(M × 10⁻⁵) | |
|---|---|---|---|
| | (before extraction) | (after extraction) | % removed |
| Pb | 0.01 | 4.14 | 99.59 |
| Co | 0.01 | — | 100 |
| Cu | 0.01 | 8.98 | 99.99 |

TABLE 4
Results of various transition metal nitrates
extracted from water by [eth-hex-en][Tf₂N]

| | [Metal]/(M) | | | |
|---|---|---|---|---|
| | (before | [Metal]/(M × 10⁻⁵) | % | % |
| | extraction) | (after extraction) | remaining | removed |
| Ni | 0.01 | 3.44 | 0.34 | 99.66 |
| Pb | 0.01 | 4.14 | 0.41 | 99.59 |
| Zn | 0.01 | 3.36 | 0.34 | 99.66 |
| Cu | 0.01 | 8.98 | 0.01 | 99.99 |

### Example 3: Electrochemical Measurements and Deposition

After removal of the aqueous phase and drying of the IL the chelated metals may be electrochemically deposited in order to recycle the IL. Electrochemical measurements were carried out using a VersaSTAT 3 potentiostat with VersaStudio software from Princeton Applied Research. Cyclic voltammetry was conducted in a standard three-electrode glass cell with Teflon coated carbon paper as the working electrode, 1 cm² platinum plate electrodes as the counter electrode and a Ag|AgNO₃ reference electrode. The ionic liquid electrolyte was purged with nitrogen with gentle stirring for 30 min and a nitrogen atmosphere was maintained during the electrochemical experiments. The temperature of the cell was controlled by immersing into an oil bath. Deposition experiments were performed using two-electrode chronoamperometry, with a potential difference of −3 V between the working carbon paper electrode and the working platinum electrode.

First a cyclic voltammogram of [eth-hex-en][Tf₂N] at 22° C., shown in FIG. 6, was recorded, and exhibited an electrochemical window of around 2 V. This is on the lower end of typical electrochemical windows (ECW) reported for ILs [30] but is still much higher than water (1.23 V). When 0.01M Cu(NO₃)₂ is added to the system the two-electron reduction of Cu(II) to Cu(0) is observed, as indicated by a broad cathodic peak at around −1.0 V. The corresponding oxidation peak is not observed due to the insignificant amount of metal deposited during the cycle compared to the large reservoir of metal ions in the bulk IL. As the complexed copper is reduced to Cu(I) the [Cu(eth-hex-en)₂][Tf₂N]₂ complex dissociates resulting in deposition of the Cu onto the working electrode (FIG. 6, inset). The deposition was highlighted during a potentiostatic experiment (chronoamperometry) using a platinum working electrode. It is interesting to note that the electrochemical window extends now to ˜2.5 V and reaches a lower cathodic limit, suggesting that the chelated IL is less susceptible to decomposition. These large electrochemical windows allows for overpotentials to be applied for fast deposition (for improved deposition kinetics). Cobalt and lead also exhibit broad two-electron reduction peaks at around −0.7 and −2.4 V respectively.

In order to recycle the IL the deposition/precipitation of metal ions on a platinum electrode after chronoamperometry was demonstrated (−3 V for 12 hrs at 22° C.). After 12 hrs, 11 μmol of copper was deposited from 4 mL of IL with an initial concentration of metal ions of 10 mM (Table 6). Similar results were observed for the other metals.

TABLE 4
Total charge and moles of metal ions
deposited after 12 hrs chronoamperometry.

| Metal | Charge/(mC) | Moles/(μmol) |
|---|---|---|
| Cu | 2119 | 10.99 |
| Pb | 2151 | 11.16 |
| Co | 2223 | 11.53 |

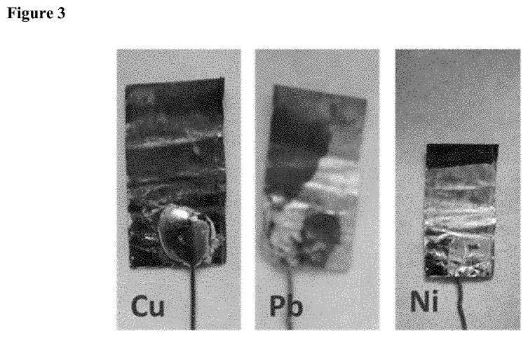

FIG. 3 demonstrates the deposition of cupric ions on a platinum electrode in a separate chronoamperometry experiment (−2.8 V for 3600 s at 50° C.). After 3600 s, 0.45 mmol of copper was deposited from an initial concentration of 0.4 M.

### REFERENCES CITED

1. P. B. Tchounwou, C. G. Yedjou, A. K. Patlolla, D. J. Sutton, Heavy Metals Toxicity and the Environment, E X S, 2012, 101, 133-164.
2. H. Bradl, Editor. Heavy Metals in the Environment: Origin, Interaction and Remediation Volume 6. London: Academic Press, 2002.
3. S. Babel, T. A. Kumiawan, Various treatment technologies to remove arsenic and mercury from contaminated groundwater: an overview, Proceedings of the First International Symposium on Southeast Asian Water Environment, Bangkok, Thailand, 2003, 24-25, 433-440.
4. J. H. Duffus, Heavy metals-a meaningless term?, Pure Appl. Chem., 2002, 74, 793-807.
5. K. C. Kang, S. S. Kim, J. W. Choi, S. H. Kwon, Competitive adsorption characteristics of Co2+, Ni2+, and Cr2+ by IRN-77 cation exchange resin in synthesized wastewater, Chemosphere, 2004, 56, 131-147.
6. B. Alyüz, S. Veli, Kinetics and equilibrium studies for the removal of nickel and zinc from aqueous solutions by ion exchange resins, J. Hazard. Mater., 2009, 167, 482-488.
7. E. Sampera, M. Rodrigueza, M. A. De la Rubia, D. Prats, Removal of metal ions at low concentrations by micellar-enhanced ultrafiltration (MEUF) using sodium dodecyl sulfate (SDS) and linear alkylbenzene sulfonate (LAS), Sep. Purif., Technol., 2009, 65, 337-342.
8. Q. Chang, G. Wang, Study on the macromolecular coagulant PEX which traps heavy metals, Chem. Eng. Sci., 2007, 62, 4636-4642.
9. M. Plattes, A. Betrand, B. Schmitt, J. Sinner, F. Versraeten, J. Welfring, Removal of tungsten oxyanions from industrial wastewater by precipitation coagulation and flocculation processes, J. Hazard. Mater. 2007, 148, 613-615.
10. Barakat M. A., New trends in removing heavy metals from industrial wastewater, Arabian J. Chem., 2011, 4, 361-377.
11. R. Apiratikul, P. Pavasant, Batch and column studies of biosorption of heavy metals by Caulerpa lentillifera, Bioresour. Technol., 2008, 99, 2766-2777.
12. Y. Ku, I. L. Jung, Photocatalytic reduction of Cr(VI) in aqueous solutions by UV irradiation with the presence of titanium dioxide, Water Res., 2001, 35, 135-142.
13. M. M. Matlock, K. R. Henke, D. A. Atwood, Effectiveness of commercial reagents for heavy metal removal from water with new insights for future chelate designs, J. Hazard. Mater., 2002, 92, 129-142.
14. Y. Xu, F. Zhang, Experimental research on heavy metal wastewater treatment with dipropyl dithiophosphate, J. Hazard. Mater., 2006, 137, 1636-1642.
15. I. K. Wang, Y. T. Hung, N. K. Shammas, Advanced physicochemical treatment technologies. In: Handbook of Environmental Engineering, vol. 5, Humana, N.J., 2007.
16. M. L. Dietz, J. A. Dzielawa, Ion-exchange as a mode of cation transfer into room-temperature ionic liquids containing crown ethers: implications for the “greenness” of ionic liquids as diluents in liquid-liquid extraction, Chem. Commun., 2001, 2124-2125.
17. A. E. Visser, R. P. Swatloski, W. M. Reichhert, R. Mayton, S. Sheff, A. Wierzbicki, J. H. Davis Jr, R. D. Rogers, Task-specific ionic liquids for the extraction of metal ions from aqueous solutions, Chem. Commun., 2001, 135-136.
18. R. S. Kalb, Method for Producing Ionic Liquids, Ionic Solids or Mixtures thereof, 2005, WO2005/021484.
19. L. Fischer, T. Falta, G. Koellensperger, A. Stojanovic, D. Kogelnnig, M. Galanski, R. Krachler, B. K. Keppler, S. Hann, Ionic Liquids for extraction of metals and metal containing compounds from communal and industrial waste water, Water Res., 2011, 45, 4601-4614.
20. D. Depuydt, L. Liu, C. Glorieux, W. Dehaen, K. Binnemans, Homogeneous liquid-liquid extraction of metal ions with non-fluorinated bis(2-ethylhexyl)phosphate ionic liuqids having a lower critical solution temperature in combination with water, Chem. Commun., 2015, 51, 14183-14186.
21. M. A. Valdes Vergara, I. V. Lijanova, N. V. Likhanova, O. Olivares Xometl, D. Jaramillo Vigueras, A. J. Morales Ramirez, Recycling and recovery of ammonium-based ionic liquids after extraction of metal cations from aqueous solutions, Separation and Purif. Technol., 2015, 155, 110-117.
22. S. Takeura, S. Kawakami, M. Harada, M. Iida, Solvation Structure of a Copper(II) Ion in Protic Ionic Liuqids Comprising N-Hexylethylenediamine, Inorg. Chem., 2014, 53, 9667-9678.
23. M. Watanabe, C. Nakayama, H. Yasuda, M. Harada, M. Iida, Interactions of nickel(II) ions in protic ionic liuqids comprising N-hexyl(or N-2-ethylhexyl)ethylenediamines, J. Molec. Liq., 2016, 214, 77-85.
24. M. Iida, C. Baba, M. Inoue, H. Yoshida, E. Taguchi, H. Furusho, Ionic Liquids of Bis(alkylethylenediamine)silver(I) Salts and the Formation of Silver(0) Nanoparticles from the Ionic Liquid System, Chem. Eur. J., 2008, 14, 5047-5056.
25. M. Iida, H. Er, N. Hisamatsu, T. Tanase, Hydrophilic-Hydrophobic Balance of Bis(octylethylenediamine) Zn (II), Cd (II), and Pd(II) Chlorides in Methanol/Water and Chloroform/Water Systems, Chem. Lett., 2000, 518-519.
26. A. J. Bruno, S. Chaberek, A. E. Martell, The Preparation and Properties of N-Substituted Ethylenediaminetriacetic Acids, J. Am. Chem. Soc., 1956, 78, 2723-2728.
27. P. Brown, S. Voskian, T. A. Hatton, CO2 Capture and Release with Electrochemically Mediated Ionic Liquids, Submitted, 2016.
28. M. Stem, T. A. Hatton, Bench-scale demonstration of CO2 capture with electrochemically-mediated amine regeneration, RSC Adv., 2014, 4, 5906-5914.
29. S. Schaltin, N. R. Brooks, J. Sniekers, D. Depuydt, L. Van Meervelt, K. Binnemans, J. Fransaer, Phys. Chem. Chem. Phys., 2013, 15, 18934-18943.
30. P. A. Z. Suarez; V. M. Selbach; J. E. L. Dullius; S. Einloft; C. M. S. Piatnicki; D. S. Azambuja; R. F. de Souza; J. Dupont, Electrochimica Acta 1997, 42, 2533.
31. A. J. Bruno, S. Chaberek, A. E. Martell, J. Am. Chem. Soc., 1956, 78, 2723-2728.
32. M. Iida, S. Kawakami, E. Syouno, H. Er, E. Taguchi, J. Coll. Int. Sci., 2011, 356, 630-638.
33. J. Jacquemin, P. Husson, A. A. H. Padua, V. Majer, Green Chem., 2006, 8, 172-180.
34. P. Brown, C. P. Butts, J. Eastoe, D. Fermin, I. Grillo, H. Lee, D. Parker, D. Plana, R. M. Richardson, Langmuir, 2012, 28, 2502-2509.

### INCORPORATION BY REFERENCE

All US and PCT patent application publications and US patents cited herein are hereby incorporated by reference in their entirety as if each individual publication or patent was specifically and individually indicated to be incorporated by reference. In case of conflict, the present application, including any definitions herein, will control.

### EQUIVALENTS

While specific embodiments of the subject invention have been discussed, the above specification is illustrative and not restrictive. Many variations of the invention will become apparent to those skilled in the art upon review of this specification and the claims below. The full scope of the invention should be determined by reference to the claims, along with their full scope of equivalents, and the specification, along with such variations.

1. A method of removing metal cations from an ionic liquid mixture, comprising:
providing an ionic liquid mixture comprising an ionic liquid and a plurality of metal cations; and
applying an electrical potential to the ionic liquid mixture, thereby removing from the ionic liquid mixture the plurality of metal cations.

2. A method of removing metal cations from an aqueous mixture, comprising:
providing an aqueous mixture comprising water and a plurality of metal cations;
contacting the aqueous mixture with an ionic liquid, thereby forming an ionic liquid mixture comprising the ionic liquid and the plurality of metal cations; and
applying an electrical potential to the ionic liquid mixture, thereby removing from the ionic liquid mixture the plurality of metal cations.

3. The method of claim 1, wherein applying the electrical potential causes the plurality of metal cations to be electrochemically reduced.

4. The method of claim 1, wherein applying the electrical potential causes the plurality of metal cations to be electrochemically reduced to metal atoms.

5. The method of claim 1, wherein the metal cations have a charge of +2.

6. The method of claim 5, wherein the metal cations are cations of Mg, Fe, Hg, Sr, Sn, Ca, Cd, Zn, Co, Cu, Pb, Ni, Sc, V, Cr, Mn, or Ag.

7. The method of claim 6, wherein the metal cations are cations of Ni, Zn, Cu, Pb, or Co.

8. The method of claim 1, wherein the ionic liquid comprises a cation and an anion; and the cation is represented by the following structural formula: 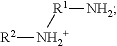
wherein, independently for each occurrence:
R¹ is —(C(R)₂)ₙ—;
n is 2, or 3;
R² is —(C(R′)₂)ₘ—R″;
m is 1, 2, 3, 4, 5, 6, 7, 8, 9, or 10; and
R is H, F, C₁-C₃ alkyl, or C₁-C₃ fluoroalkyl;
R′ is H, F, C₁-C₈ alkyl, or C₁-C₈ fluoroalkyl; and
R″ is H, F, C₁-C₃ alkyl, C₁-C₃ fluoroalkyl, C₁-C₃ alkyloxy, C₁-C₃ fluoroalkyloxy, C₆-C₁₀ aryl, C₂-C₈ alkenyl or C₂-C₈ fluoroalkenyl; wherein each instance of C₆-C₁₀ aryl is optionally substituted with one, two, three, four or five substituents independently selected from the group consisting of F, C₁-C₃ alkyl, C₁-C₃ fluoroalkyl, C₁-C₃ alkyloxy, and C₁-C₃ fluoroalkyloxy.

9. The method of claim 8, wherein n is 2.

10. (canceled)

11. (canceled)

12. The method of claim 8, wherein R² is 2-ethylhexyl.

13. The method of claim 8, wherein the anion is boron tetrafluoride, phosphorus tetrafluoride, phosphorus hexafluoride, alkylsulfonate, fluoroalkylsulfonate, arylsulfonate, bis(alkylsulfonyl)amide, bis(fluoroalkylsulfonyl)amide, bis(arylsulfonyl)amide, (fluoroalkylsulfonyl)(fluoroalkylcarbonyl)amide, halide, nitrate, nitrite, sulfate, hydrogensulfate, alkyl sulfate, aryl sulfate, carbonate, bicarbonate, carboxylate, phosphate, hydrogen phosphate, dihydrogen phosphate, hypochlorite, or an anionic site of a cation-exchange resin.

14. (canceled)

15. The method of claim 13, wherein the anion is methanesulfonate, trifluoromethanesulfonate, benzenesulfonate, p-toluenesulfonate, bis(methanesulfonyl)amide, bis(trifluoromethanesulfonyl)amide, bis(benzenesulfonyl)amide, or bis(p-toluenesulfonyl)amide.

16. (canceled)

17. The method of claim 13, wherein the anion is bis(trifluoromethanesulfonyl)amide or (trifluoromethanesulfonyl)(trifluoroacetyl)amide.

18. The method of claim 13, wherein the anion is bis(trifluoromethanesulfonyl)amide.

19. The method of claim 1, wherein the metal cations have a charge of +3.

20. The method of claim 19, wherein the metal cations are cations of La, Ce, Pr, Nd, Pm, Sm, Eu, Gd, Tb, Dy, Ho, Er, Tm, Yb, or Lu.

21. The method of claim 19, wherein the metal cations are cations of Ac, Th, Pa, U, Np, Pu, Am, Cm, Bk, Cf, Es, Fm, Md, No, or Lr.

22. The method of claim 1, wherein the ionic liquid comprises a cation and an anion; and the cation is represented by the following structural formula: 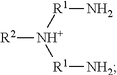
wherein, independently for each occurrence:
R¹ is —(C(R)₂)ₙ—;
n is 2, or 3;
R² is —(C(R′)₂)ₘ—R″;
m is 1, 2, 3, 4, 5, 6, 7, 8, 9, or 10; and
R is H, F, C₁-C₃ alkyl, or C₁-C₃ fluoroalkyl;
R′ is H, F, C₁-C₈ alkyl, or C₁-C₈ fluoroalkyl; and
R″ is H, F, C₁-C₃ alkyl, C₁-C₃ fluoroalkyl, C₁-C₃ alkyloxy, C₁-C₃ fluoroalkyloxy, C₆-C₁₀ aryl, C₂-C₈ alkenyl or C₂-C₈ fluoroalkenyl; wherein each instance of C₆-C₁₀ aryl is optionally substituted with one, two, three, four or five substituents independently selected from the group consisting of F, C₁-C₃ alkyl, C₁-C₃ fluoroalkyl, C₁-C₃ alkyloxy, and C₁-C₃ fluoroalkyloxy.

23. The method of claim 22, wherein n is 2.

24. (canceled)

25. (canceled)

26. The method of claim 22, wherein R² is 2-ethylhexyl.

27. The method of claim 22, wherein the anion is boron tetrafluoride, phosphorus tetrafluoride, phosphorus hexafluoride, alkylsulfonate, fluoroalkylsulfonate, arylsulfonate, bis(alkylsulfonyl)amide, bis(fluoroalkylsulfonyl)amide, bis(arylsulfonyl)amide, (fluoroalkylsulfonyl)(fluoroalkylcarbonyl)amide, halide, nitrate, nitrite, sulfate, hydrogensulfate, alkyl sulfate, aryl sulfate, carbonate, bicarbonate, carboxylate, phosphate, hydrogen phosphate, dihydrogen phosphate, hypochlorite, or an anionic site of a cation-exchange resin.

28. (canceled)

29. The method of claim 27, wherein the anion is methanesulfonate, trifluoromethanesulfonate, benzenesulfonate, p-toluenesulfonate, bis(methanesulfonyl)amide, bis(trifluoromethanesulfonyl)amide, bis(benzenesulfonyl)amide, or bis(p-toluenesulfonyl)amide.

30. (canceled)

31. The method of claim 27, wherein the anion is bis(trifluoromethanesulfonyl)amide or (trifluoromethanesulfonyl)(trifluoroacetyl)amide.

32. The method of claim 27, wherein the anion is bis(trifluoromethanesulfonyl)amide.
